(19) United States
(12) Patent Application Publication
(10) Pub. No.: US 2014/0255554 A1
(43) Pub. Date: Sep. 11, 2014

(54) CHEWY FOOD COMPOSITIONS

(71) Applicant: NESTEC S.A., Vevey (CH)

(72) Inventors: Fanny Bigeard, Hamelet (FR); Patrick Pibarot, Guillaucourt (FR); Pierre Reynes, Camon (FR); Robert Tellier, Vecquemont (FR)

(21) Appl. No.: 14/346,365

(22) PCT Filed: Aug. 29, 2012
(86) PCT No.: PCT/US2012/052804

§ 371 Date: May 28, 2014

Related U.S. Application Data
(60) Provisional application No. 61/575,874, filed on Sep. 29, 2011.

(51) Int. Cl. A23K 1/00

(52) U.S. Cl. CPC A23K 1/003
USPC 426/92; 426/89; 426/103; 426/516; 426/514; 426/656

(57) ABSTRACT

The invention provides food compositions having a chewy texture and methods for making the chewy food compositions. In one aspect, the food composition includes a moisture content and an Aw sufficient to provide the food composition with a chewy texture. In one aspect, an outer shell having a chewy texture encloses a soft meaty inner filling. The shell can have a moisture content ranging from about 15% to about 24% and an Aw ranging from about 0.7 to about 0.84.

### CROSS REFERENCE TO RELATED APPLICATIONS

This application claims priority to U.S. Provisional Application Ser. No. 61/575,874 filed Sep. 29, 2011, the disclosure of which is incorporated herein by this reference.

### BACKGROUND OF THE INVENTION

1. Field of the Invention

The invention relates generally to food compositions and particularly to food compositions having a chewy texture and methods of making such chewy food compositions.

2. Description of Related Art

Improving animal acceptance of companion animal food compositions is a constant effort in the highly competitive companion animal food industry. With estimated U.S. retail sales approaching $18 billion, a small increase in market share is worth substantial money.

Pet treats with long occupation times (e.g., chewing, playing, and/or swallowing) have a hard texture and are generally associated with bone or rawhide. Pets that consume these pet treats usually require a long time (e.g., greater than 15 minutes) before the bone or rawhide is able to be fully chewed and consumed. If the bone or rawhide is too hard, the pet will give up and leave the remaining bone or rawhide uneaten. In addition, forming bite-sized pet treats such as pillow shaped pet treats are difficult with pet treats having hard texture as the mechanical post-forming of the hard pet treat after extruding is almost impossible.

Soft pet treats such as those with a brittle or soft shell are consumed almost instantaneously (e.g., 10 seconds or less). This occupies the pet for a short of a time leaving the pet wanting more, thereby causing the pet to eat more treats. As a result, soft pet treats may not be beneficial to the pet from a health standpoint if too many are consumed.

Therefore there is a need for a treat that has a flexible, meaty texture and taste and that will occupy the pet for an extended time before being completely consumed.

### SUMMARY OF THE INVENTION

It is, therefore, an object of the present invention to provide food compositions having a chewy texture.

It is another object of the invention to provide food compositions including a shell having a chewy texture surrounding a filling.

It is a further object of the invention to provide methods of making food compositions having a chewy texture.

It is a further object of the invention to provide methods of making food compositions having a chewy texture.

It is yet another object of the present invention to provide containers and packages suitable for including food compositions having a chewy texture.

It is yet another object of the present invention to provide methods of manufacturing food compositions having a chewy texture in a container or package.

One or more of these or other objects are achieved by providing food compositions including a moisture content and an Aw sufficient to provide the food compositions with a chewy texture. The moisture content ranges from about 15% to about 24% and the Aw ranges from about 0.7 to about 0.84. In one aspect, an outer shell having the chewy texture encloses an inner filling.

Other and further objects, features, and advantages of the present invention will be readily apparent to those skilled in the art.

### BRIEF DESCRIPTION OF THE DRAWINGS

FIG. 1A shows a perspective view of a food composition having a chewy texture in an embodiment of the invention.

FIG. 1B shows a cross-section of a food composition including a shell having a chewy texture surrounding a filling in an embodiment of the invention.

FIG. 2 shows a cross-section of a food composition including a shell having a chewy texture surrounding an air pocket in an embodiment of the invention.

FIG. 3 shows a cross-section of a food composition having no filling in an embodiment of the invention.

### DETAILED DESCRIPTION OF THE INVENTION

### Definitions

The term “animal” means any animal that could benefit from or enjoy food compositions having a chewy texture, including human, avian, bovine, canine, equine, feline, hicrine, lupine, murine, ovine, or porcine animals.

The term “companion animal” means domesticated animals such as cats, dogs, rabbits, guinea pigs, ferrets, hamsters, mice, gerbils, horses, cows, goats, sheep, donkeys, pigs, and the like.

The term “Aw” means water activity.

The term “hard texture” means a texture requiring a chew time of greater than 15 minutes to be completely chewed and consumed by an animal chewing a composition having a hard texture.

The term “soft texture” means a texture requiring a chew time of less than 30 seconds to be completely chewed and consumed by an animal chewing a composition having a soft texture.

The term “chewy texture” means a texture that provides a chewing time between that provided by a food composition having a hard texture and a food composition having a soft texture. For example, a food composition having a chewy texture can provide a chew time ranging from about 1 minute to about 12 minutes when chewed by an animal.

The term “single package” means that the components of a kit are physically associated in or with one or more containers and considered a unit for manufacture, distribution, sale, or use. Containers include, but are not limited to, bags, boxes, cartons, bottles, packages of any type or design or material, over-wrap, shrink-wrap, affixed components (e.g., stapled, adhered, or the like), or combinations thereof. A single package may be containers of individual components physically associated such that they are considered a unit for manufacture, distribution, sale, or use.

The term “virtual package” means that the components of a kit are associated by directions on one or more physical or virtual kit components instructing the user how to obtain the other components, e.g., a bag or other container containing one component and directions instructing the user to go to a website, contact a recorded message or a fax-back service, view a visual message, or contact a caregiver or instructor to obtain instructions on how to use the kit or safety or technical information about one or more components of a kit.

As used herein, ranges are used herein in shorthand, so as to avoid having to list and describe each and every value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “food composition” or “a method of making a food composition” includes a plurality of such “food compositions” or “methods.” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context.

The terms “comprising” or “including” are intended to include embodiments encompassed by the terms “consisting essentially of” and “consisting of”. Similarly, the term “consisting essentially of” is intended to include embodiments encompassed by the term “consisting of”.

All percentages expressed herein are by weight of the total weight of the food composition unless expressed otherwise. For example, an ingredient in an amount of 25% by weight means that the amount of the ingredient is 25% of the total weight of the food composition. Thus, if the total weight of the food composition is 100 grams, the actual amount of the ingredient corresponding to 25% by weight would be 25 grams.

The methods and compositions and other advances disclosed here are not limited to particular methodology, protocols, ingredients, components and reagents described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

### The Invention

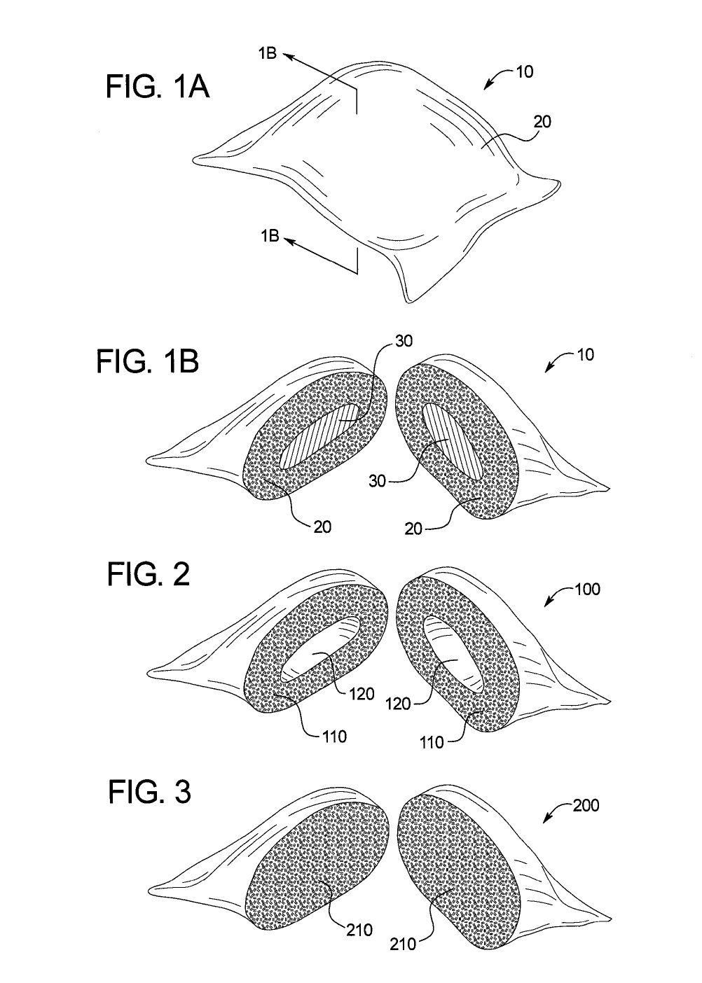

In one aspect shown by FIGS. 1A-1B, the invention provides a food composition 10 including a shell 20 having a moisture (e.g., water) content and an Aw sufficient to provide shell 20 with a chewy texture. A suitable filling 30 is contained within shell 20. The weight ratio of shell 20 to filling 30 of food composition 10 ranges from about 15:85 to about 70:30. As shown in FIG. 1A, food composition 10 can be in the shape of a pillow and be sized to fit in an animal's mouth (e.g., bite-sized). Food composition 10 can have any suitable shape and size in alternative embodiments of the invention.

To provide the chewy texture, shell 20 includes a moisture content ranging from about 15% to about 24% and an Aw ranging from about 0.7 to about 0.84. In another embodiment, shell 20 includes a moisture content ranging from about 15% to about 20% and an Aw ranging from about 0.7 to about 0.75. In a further embodiment, shell 20 includes a moisture content ranging from about 9% to about 25% and an Aw ranging from about 0.5 to about 0.85. In addition, shell 20 can have a penetration force ranging from about 90 N to about 220 N and a flexion force ranging from about 200 N to about 600 N.

Shell 20 can be made from any suitable edible ingredients and amounts thereof that provide shell 20 with a chewy texture as described herein. Suitable edible ingredients can include grains, starches, meat meals, proteins, fibers, sugars, minerals, aromas, colors, flavors, oils, humectants, preservatives, or combinations thereof.

Filling 30 can also have a moisture content and an Aw sufficient to provide the filling with a soft texture. For example, filling 30 includes a moisture content ranging from about 15% to about 24% and an Aw ranging from about 0.7 to about 0.84. In another embodiment, filling 30 includes a moisture content ranging from about 15% to about 20% and an Aw ranging from about 0.7 to about 0.75. In a further embodiment, filling 30 includes a moisture content ranging from about 9% to about 25% and an Aw ranging from about 0.5 to about 0.85.

Filling 30 can be made from any suitable edible ingredients and amounts thereof, for example, to provide a filling having a chewy texture and/or that is desirable for an animal to consume. These ingredients include grains, starches, meat meals, proteins, fibers, sugars, minerals, aromas, colors, flavors, oils, humectants, preservatives, acids, or combinations thereof.

In another aspect shown by FIG. 2, the invention provides a food composition 100 including a shell 110 having a chewy texture surrounding an air pocket 120. Shell 110 can be made from the same ingredients and having the same textural qualities as shell 20 discussed above. Food composition 100 can be in the shape of a pillow and be sized to fit in an animal's mouth. It should be appreciated that food composition 100 can have any suitable shape and size in alternative embodiments of the invention.

In an alternative aspect shown by FIG. 3, the invention provides a food composition 200 in the form of a solid composition 210 having a chewy texture that has no filling. Solid composition 20 includes a moisture content and an Aw sufficient to provide the food composition with a chewy texture. To provide the chewy texture, solid composition 210 can include a moisture content ranging from about 15% to about 24% and an Aw ranging from about 0.7 to about 0.84. In another embodiment, solid composition 210 includes a moisture content ranging from about 15% to about 20% and an Aw ranging from about 0.7 to about 0.75. In a further embodiment, solid composition 210 includes a moisture content ranging from about 9% to about 25% and an Aw ranging from about 0.5 to about 0.85. In addition, solid composition 210 can have a penetration force ranging from about 90 N to about 220 N and a flexion force ranging from about 200 N to about 600 N.

Food compositions 10, 100, and 200 can be companion animal food compositions. Companion animal food compositions 10, 100, and 200 can be extruded companion animal food compositions made using conventional extrusion or coextrusion processes. In various embodiments, the food compositions are dog or cat food compositions.

By having a chewy texture according to the invention, food compositions 10, 100 and 200 can provide a chew time ranging from about 1 minute to about 12 minutes when chewed by an animal. Alternatively, the chewy texture can enable food compositions 10, 100 and 200 to have a chew time ranging from about 5 minutes to about 10 minutes or from about 3 minutes to about 9 minutes when chewed by an animal. A food composition having a chew time between about 1 to about 12 minutes sufficiently occupies an animal without the food composition being consumed too quickly or requiring a very long period of chew time.

Any animals compatible with the food compositions are suitable for consuming the food compositions. In various embodiments, the animals are human or non-human animals. In some embodiments, the animals are companion animals. In others, the animals are dogs and cats.

In another aspect, the invention provides a method for making food compositions. The methods comprise providing a shell having a moisture content and an Aw sufficient to provide the shell with a chewy texture and coextruding the shell with a filling to form a coextruded food composition. Conventional coextrusion methods can be used to coextrude the filling inside the shell. The method can further comprise cutting the coextruded food composition and crimping edges of the cut food composition to form a center-filled food composition (e.g., a pillow shaped companion animal food). Instead of a solid filling, the filling can be an air pocket and can be made by suitable coextruding methods to provide an air pocket within the shell.

The chewy texture of the shell will have the properties according to any embodiments of the invention disclosed herein. For example, the chewy texture of the shell can be supple and cohesive enough to be pinched, squeezed, crimpled or stamped. After post-forming, the chewy texture of the shell can provide a good shape memory (e.g., keeps shape integrity after temperature cool down). This enables the shell to be shaped in any suitable manner.

In a further aspect, the invention provides a kit comprising in a single package or in separate containers in a virtual package, as appropriate for a kit component, (A) a food composition including a moisture content and an Aw sufficient to provide the food composition with a chewy texture, and (B) one or more of: (1) a description of the benefits of the food composition including the chewy texture; (2) instructions for how to administer the food composition including the chewy texture; (3) a second food composition; (4) a serving platter for serving the food composition including the chewy texture; or (5) a serving utensil for serving the food composition including the chewy texture.

When the kit comprises a virtual package, the kit can be limited to instructions in a virtual environment in combination with one or more physical kit components. The kits may contain the kit components in any of various combinations and/or mixtures. For example, in one embodiment, the kit includes a container having a food composition including a chewy texture described herein and a second food composition. In another embodiment, the kit includes a container having a food composition including a chewy texture described herein and a serving platter.

In another aspect, the invention provides a means for communicating information about or instructions for a food composition including a moisture content and an Aw sufficient to provide the food composition with a chewy texture for one or more of: (1) administering the food composition having the chewy texture to an animal; (2) describing the benefits of the food composition including the chewy texture; or (3) promoting the health or wellness of an animal with the food composition having the chewy texture.

The communication means can be a document, digital storage media, optical storage media, audio presentation, or visual display containing the information or instructions. More specifically, the means can be a displayed website, a visual display kiosk, a brochure, a product label, a package insert, an advertisement, a handout, a public announcement, an audiotape, a videotape, a DVD, a CD-ROM, a computer readable chip, a computer readable card, a computer readable disk, a USB device, a FireWire device, a computer memory, or any combinations thereof.

In another aspect, the invention provides a package including indicia describing a food composition including a moisture content and an Aw sufficient to provide the food composition with a chewy texture. The indicia can be in the form of words, symbols, pictures, photographs, figures, or combinations thereof to show details or examples of the food composition having the chewy texture described herein. The package can further contain a food composition including a moisture content and an Aw sufficient to provide the food composition with a chewy texture inside a container.

In a further aspect, the invention provides a method for manufacturing a container having a food composition. The manufacturing method comprises providing a food composition including a moisture content and an Aw sufficient to provide the food composition with a chewy texture, extruding the food composition, cutting the extruded food composition into food pieces, and filling the container with the pieces of the food composition having the chewy texture. The manufacturing method can further comprise retorting the container. Alternatively, the chewy food composition can be coextruded with a filling and subsequently cut into pieces and packaged in a container.

In another aspect, the invention provides continuous production lines capable of manufacturing a container including a food composition having a chewy texture. More specifically, the continuous production lines can include various devices for making a container having the food composition with the chewy texture. For example, the continuous production lines can include one or more mechanical mixers for combining the ingredients of the shell and the filling. The continuous production lines can include a coextruder for coextruding the filling within the shell. The coextruded food composition having the chewy texture can be further cut into pieces and have the edges crimped to provide pillow-shaped piece that can be filled in a container. The filled container can then be sealed or closed and taken to a steamer/retorting station. A conveyor belt can be used to transport the containers from one station to another station of the continuous production lines.

In a further aspect, the invention provides multi-pack packages including 1) a plurality of containers arranged in an array, each of the plurality of containers including a food composition having a chewy texture described herein, and 2) one or more devices for retaining the containers in the array. In various embodiments, the devices are boxes made from paper, plastic, polymers, or a combination thereof. In others, the devices are systems of connected plastic rings affixed to each of the containers. In still others, the devices are wrappings of plastic of similar materials, e.g., twelve cans stacked in an array and wrapped in plastic. In some embodiments, the multi-pack packages have one or more handles affixed to the multi-pack packages to facilitate handling and transporting the multi-pack packages.

In other embodiments, the devices further include one or more windows that permit the package contents to be viewed without opening the multi-pack package. In some embodiments, the windows are a transparent portion of the devices. In others, the windows are missing portions of the devices that permit the containers to be viewed without opening the multi-pack package.

In preferred embodiments, the multi-pack packages further include one or more indicia describing the contents of the containers in the packages. The indicia can be in the form of labels, printing on the packages, stickers, and the like and include words, symbols, pictures, photographs, figures, or combinations thereof to provide detail or examples of the food composition having the chewy texture described herein. In a preferred embodiment, a label is affixed to the multi-pack packages containing a word or words, picture, design, acronym, slogan, phrase, or other device, or combination thereof, that indicates that the content of the package contains a companion animal food composition having a chewy texture.

### EXAMPLES

The invention can be further illustrated by the following examples, although it will be understood that these examples are included merely for purposes of illustration and are not intended to limit the scope of the invention unless otherwise specifically indicated.

### Example 1

A 200 kg batch of a shell composition was prepared as follows. Dry ingredients (“Dries”) and liquid ingredients (“Liquids”) were weighed out in the proportions shown in Table 1. The Dries were added to a ribbon blender and mixed for 10 minutes after which the blend was ready for feeding into the extruder-cooker. The Liquids were combined in a stainless steel mixing tank with continuous mixing for 5 minutes. This mixture was then ready for injection into the extruder cooker.

TABLE 1
Shell Compositions

| | OUTER Pocket (Shell) | |
|---|---|---|
| | Formula | % |
| DRIES | Wheat grain/flour | 14 |
| | Starches | 32 |
| | Meat meals | 5.5 |
| | Proteins | 4.5 |
| | Fibers | 3.5 |
| | Sugars | 2 |
| | Minerals | 3.5 |
| | Sodium Chloride | 2 |
| | Potassium Sorbate | 0.5 |
| | Calcium Propionate | 0.3 |
| | Other additives | 3.5 |
| | Coloring agent | 0.2 |
| LIQUIDS | Water | 12.5 |
| | Oil (Fish or Poultry) | 1.5 |
| | Humectant (Glycerin) | 14.5 |
| | TOTAL | 100.00 |

### Example 2

A 200 kg batch of a filling was prepared as follows. Dry ingredients (“Dries”) and liquid ingredients (“Liquids”) were weighed out in the proportions shown in Table 2. The Dries were added to a ribbon blender and mixed for 10 minutes after which the blend was ready for feeding into the extruder-cooker. The Liquids were combined in a stainless steel mixing tank with continuous mixing for 5 minutes.

TABLE 2
Filling Compositions

| | INNER (Filling) Formula | % |
|---|---|---|
| DRIES | Wheat grain/flour | 41.30 |
| | Meat meals | 14.00 |
| | Proteins | 4.00 |
| | Fibers | 2.20 |
| | Sugar (Crystalline) | 5.00 |
| | Sodium Chloride | 1.00 |
| | Potassium Sorbate | 0.50 |
| | Calcium Propionate | 0.30 |
| | Other preservatives | 1.00 |
| | Aroma | 0.50 |
| | Coloring agent | 0.70 |
| LIQUIDS | Water | 14.30 |
| | Humectant (Glycerin) | 11.70 |
| | Oil (Fish or Poultry) | 3.00 |
| | Phosphoric Acid | 0.50 |
| | TOTAL | 100.00 |

### Example 3

To form the shell, the dry blend from Example 1 is fed into an EVOLUM® 53 extruder operating at 260 rpm with a medium to high shear profile. The liquids are injected immediately after the entry of the dry blend in the weight ratio 28.5 liquids:71.5 dry blend. The extruder throughput was set at 170 kg/hour. The maximum temperature attained varied in the range 95 to 100° C. and pressure 45 to 50 bars. The barrel was vented midway and the last two heads cooled to ambient to prevent expansion.

To form the filling, the dry blend from Example 2 is fed into BC-45 extruder operating at 473 rpm with a high shear profile. The liquids are injected immediately after the entry of the dry blend in the weight ratio 29.5 liquids:70.5 dry blend. The extruder throughput was set at 108 kg/hour. The maximum temperature attained varied in the range 80 to 85° C. and pressure 45 to 50 bars. The feed was co-extruded into the shell being formed with the EVOLUM® 53 extruder.

On exiting the extruder, the filled rope was crimped and cut manually using a crimping device to form a pillow shaped product as shown in FIGS. 1A-1B. Any suitable mechanical crimping/cutting device can be used to make the pillow shaped product. The moisture content and water activity of the final product is shown in Table 3. Alternative products having a chewy texture can be made by decorating the top surface of an extruded rope (e.g., solid, filled or hollow) using a mold that provides a pattern on the surface of the extruded rope and then cutting the rope into pieces.

TABLE 3

| | | Water | | |
|---|---|---|---|---|
| | Moisture | Activity | Meat Ingredients | Oils |
| Inner | 15-24% | 0.7-0.84 | with or without | with |
| (Filling) | | | | |
| Outer | 15%-20% | 0.7-0.75 | with or without | with or |
| (Shell) | | | | without |

### Example 4

An alternate method of co-extruding the filling can be used. For this, the wet and dry ingredients are combined in a dough mixer. While continuously mixing to form a dough, the temperature is raised to 90 to 95° C. with direct or indirect steam heating. As in Example 3, the heated dough is then co-extruded into the shell with a high pressure pump such as a gear pump or a stuffer.

### Example 5

An empty pocket treat product was made using the composition from Example 1 and extruding the shell only as in Example 3, followed by the post extrusion forming as in Example 3. This product is shown in FIG. 2 and has the same moisture and water activity as shown for the shell in Table 3.

### Example 6

Table 4 shows ingredients of the shell compositions in alternative embodiments of the chewy food compositions.

TABLE 4
Shell Compositions

| | OUTER Pocket | | | |
|---|---|---|---|---|
| | (Shell) Formula | % | Range % | Examples and Variants |
| DRIES | Wheat grain/flour | 14 | 10-20 | |
| | Starches | 32 | 20-60 | Native and/or pregelatinized |
| | | | | rice, corn, wheat or other cereal |
| | | | | starches |
| | Meat meals | 5.5 | 0-7 | Rendered meals - poultry, pork |
| | | | | greaves, beef, lamb, fish |
| | Proteins | 4.5 | 4-10 | Wheat gluten, Egg white, Egg, |
| | | | | Dried digest, Dried plasma, soy |
| | | | | protein |
| | Fibers | 3.5 | 3-5 | Pea, Chicory root, beet pulp |
| | Sugars | 2 | 0-10 | Sucrose, Dextrose |
| | Minerals | 3.5 | | |
| | Sodium Chloride | 2 | 0.5-3 | |
| | Potassium Sorbate | 0.5 | | |
| | Calcium Propionate | 0.3 | | |
| | Other additives | 3.5 | | Bentonite, Vitamin Premix, |
| | | | | Calcium Hydrogen Phosphate |
| | Coloring agent | 0.2 | | Includes titanium dioxide |
| LIQUIDS | Water | 12.5 | 10-15 | |
| | Oil (Fish or Poultry) | 1.5 | 0-5 | |
| | Humectant (Glycerin) | 14.5 | 6-16 | Also other polyols (sorbitol, |
| | | | | polydextrose) |
| | TOTAL | 100.00 | | |

### Example 7

Table 5 shows ingredients of the filling compositions in alternative embodiments of the chewy food compositions.

TABLE 5
Filling Compositions

| | INNER (Filling) | | | |
|---|---|---|---|---|
| | Formula | % | Range % | Examples and Variants |
| DRIES | Wheat | 41.30 | 20-50 | |
| | grain/flour | | | |
| | Meat meals | 14.00 | 0-15 | Rendered meals - poultry, pork |
| | | | | greaves, beef, lamb, fish |
| | Proteins | 4.00 | 4-15 | Wheat gluten, Egg white, Egg, |
| | | | | Dried digest, Dried plasma, soy |
| | | | | protein |
| | Fibers | 2.20 | 1-5 | Pea, Chicory root, beet pulp |
| | Sugar | 5.00 | 0-10 | Sucrose, Dextrose |
| | (Crystalline) | | | |
| | Sodium Chloride | 1.00 | 0.5-3 | |
| | Potassium | 0.50 | | |
| | Sorbate | | | |
| | Calcium | 0.30 | | |
| | Propionate | | | |
| | Other | 1.00 | | Antioxidants (tocopherols, BHA); |
| | preservatives | | | Citric Acid |
| | Aroma | 0.50 | | Meat, Vegetable, Cooked like |
| | | | | casserole etc. |
| | Coloring agent | 0.70 | | |
| LIQUIDS | Water | 14.30 | 10-20 | |
| | Humectant | 11.70 | 6-24 | Also other polyols (sorbitol, |
| | (Glycerin) | | | polydextrose) |
| | Oil (Fish or | 3.00 | 2-5 | |
| | Poultry) | | | |
| | Phosphoric Acid | 0.50 | | |
| | TOTAL | 100.00 | | |

### Example 8

The mechanical properties of the products shown in Table 6 were measured by a TA-XT2I Texture Analyzer (Rheo Ltd., Champlan, France), a system designed to simulate the biting action of a dog's teeth, and by three-point flexion. The TA-XT2I Texture Analyzer was equipped with a specially designed cone-shaped penetrometer probe that was 12 mm long. The probe was pushed slowly into the products, descending at a rate of 2 mm/s. Measurements were made of the penetration force required to insert the probe into the products and shown in Table 6. Note: the dimension of the product from Example 3 was 90 mm (length)×65 mm (width)×35 mm (center thickness).

Standard three-point flexion tests were carried out using a traction machine (LLOYD ltd, Fareham Hampshire, UK) with a speed of 50 mm/min and a maximum flexion of 40 mm. Results for the force to bend and break (Flexion Force) and distance bent before breaking (Flexion Distance) are illustrated in Table 6.

TABLE 6

| | PRODUCTS | | |
|---|---|---|---|
| | G2-Hard | | Small Crunchy |
| | Treat* | Example 3 | Kibbles** |
| Penetration Force - Fmax (N) | 265 | 180 | 26 |
| Flexion Force - Fmax (N) | 720 | 480 | NA |
| Flexion Distance (mm) | 30 | >40 | 0 |

*Product in US 20060292288A1
**Commercial Treat Kibbles

### Example 9

The chewing duration of products used in Example 8 was tested using a fixed group of forty dogs. A veterinarian screened all participating dogs before the trial commenced to ensure each dog was in good oral health and presented with no oral defects, such as gingivitis, bleeding and/or redness of gums, missing teeth, etc. The test dogs covered a broad range of sizes. Dogs were presented with the products and their eating behavior, as seen, for example, in the duration of chewing the products, was monitored. With regard to the determination of chewing duration, only actual chewing time was recorded and any period where the dog stopped chewing was discarded from the calculation of chewing time.

Each dog's mouth was reexamined at the end of the trial. It was observed that the dogs took the products (G2 and Example 3) into their mouths, laid down on their bellies, and transferred the product to their front paws. They held the product in a slightly inclined vertical manner and began to chew, all using primarily their back teeth. When the dogs finally gnawed the product down to an end piece, they picked this up with the front teeth, chewing it a number of times further, before swallowing the remainder. The small crunchy kibbles were picked up and swallowed with hardly any chewing. The chewing times are reported in Table 7. The results are normalized and reported in terms of chewing time per unit weight (time/grams) of product to eliminate the impact product density differences.

TABLE 7

| | Chewing Time |
|---|---|
| Product | (seconds/gram) |
| G2-Hard Treat* | 15.4 |
| Example 3 | 8 |
| Small Crunchy Kibbles** | <2 |

*Product and manufacture described in US 20060292288A1
**Commercial Treat Kibbles

In the specification, there have been disclosed typical preferred embodiments of the invention. Although specific terms are employed, they are used in a generic and descriptive sense only and not for purposes of limitation. The scope of the invention is set forth in the claims. Obviously many modifications and variations of the invention are possible in light of the above teachings. It is therefore to be understood that within the scope of the appended claims the invention may be practiced otherwise than as specifically described.

What is claimed is:

1. A food composition comprising:
a shell having a moisture content and an Aw sufficient to provide the shell with a chewy texture; and
a filling within the shell.

2. The food composition of claim 1 wherein the shell comprises a moisture content ranging from about 15% to about 24% and an Aw ranging from about 0.7 to about 0.84.

3. The food composition of claim 1 wherein the shell comprises a moisture content ranging from about 15% to about 20% and an Aw ranging from about 0.7 to about 0.75.

4. The food composition of claim 1 wherein the shell comprises a moisture content ranging from about 9% to about 25% and an Aw ranging from about 0.5 to about 0.85.

5. The food composition of claim 1 wherein the shell has a penetration force ranging from about 90 N to about 220 N.

6. The food composition of claim 1 wherein the shell has a flexion force ranging from about 200 N to about 600 N.

7. The food composition of claim 1 wherein the filling has a moisture content and an Aw sufficient to provide the filling with a soft texture.

8. The food composition of claim 7 wherein the filling comprises a moisture content ranging from about 15% to about 24% and an Aw ranging from about 0.7 to about 0.84.

9. The food composition of claim 7 wherein the filling comprises a moisture content ranging from about 15% to about 20% and an Aw ranging from about 0.7 to about 0.75.

10. The food composition of claim 7 wherein the filling comprises a moisture content ranging from about 9% to about 25% and an Aw ranging from about 0.5 to about 0.85.

11. The food composition of claim 1 wherein the filling is an air pocket.

12. (canceled)

13. The food composition of claim 12 wherein the companion animal food composition is an extruded companion animal food composition.

14. The food composition of claim 1 wherein the shell includes one or more edible ingredients selected from the group consisting of grains, starches, meat meals, proteins, fibers, sugars, minerals, aromas, colors, flavors, oils, humectants, preservatives, and combinations thereof.

15. The food composition of claim 1 wherein the filling includes one or more edible ingredients selected from the group consisting of grains, starches, meat meals, proteins, fibers, sugars, minerals, aromas, colors, flavors, oils, humectants, preservatives, acids, and combinations thereof.

16. A food composition comprising a solid composition having a moisture content and an Aw sufficient to provide the solid composition with a chewy texture.

17. The food composition of claim 16 wherein the food composition comprises a moisture content ranging from about 15% to about 24% and an Aw ranging from about 0.7 to about 0.84.

18. The food composition of claim 16 wherein the food composition comprises a moisture content ranging from about 15% to about 20% and an Aw ranging from about 0.7 to about 0.75.

19. A method for making a food composition comprising:
providing a shell having a moisture content and an Aw sufficient to provide the shell with a chewy texture; and
coextruding the shell with a filling to form a coextruded food composition.

20. The method of claim 19 further comprising cutting the coextruded food composition and crimping edges of the cut food composition to form a center-filled food composition.

21. The method of claim 19 wherein the shell comprises a moisture content ranging from about 15% to about 24% and an Aw ranging from about 0.7 to about 0.84.

22. The method of claim 19 wherein the shell comprises a moisture content ranging from about 15% to about 20% and an Aw ranging from about 0.7 to about 0.75.

23. The method of claim 19 wherein the shell comprises a moisture content ranging from about 9% to about 25% and an Aw ranging from about 0.5 to about 0.85.

24. The method of claim 19 wherein the shell has a penetration force ranging from about 90 N to about 220 N.

25. The method of claim 19 wherein the shell has a flexion force ranging from about 200 N to about 600 N.

26. The method of claim 19 wherein the filling has a moisture content and an Aw sufficient to provide the filling with a soft texture.

27. The method of claim 26 wherein the filling comprises a moisture content ranging from about 15% to about 26% and an Aw ranging from about 0.7 to about 0.84.

28. The method of claim 26 wherein the filling comprises a moisture content ranging from about 15% to about 20% and an Aw ranging from about 0.7 to about 0.75.

29. The method of claim 26 wherein the filling comprises a moisture content ranging from about 9% to about 25% and an Aw ranging from about 0.5 to about 0.85.

30. The method of claim 19 wherein the filling is an air pocket.

31. The method of claim 19 wherein the food composition is a companion animal food composition.

32. The method of claim 19 wherein the companion animal food composition is an extruded companion animal food composition.

33. The method of claim 19 wherein the shell includes one or more edible ingredients selected from the group consisting of grains, starches, meat meals, proteins, fibers, sugars, minerals, aromas, colors, flavors, oils, humectants, preservatives, and combinations thereof.

34. The method of claim 19 wherein the filling includes one or more edible ingredients selected from the group consisting of grains, starches, meat meals, proteins, fibers, sugars, minerals, aromas, colors, flavors, oils, humectants, preservatives, acids, and combinations thereof.

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)
